(19) United States
(12) Patent Application Publication
(10) Pub. No.: US 2011/0060763 A1
(43) Pub. Date: Mar. 10, 2011

(54) Address search device and method for searching address

(75) Inventors: Koudai Okada, Nagoya-city (JP); Tomoo Nomura, Nagoya-city (JP)

(73) Assignee: DENSO CORPORATION, Kariya-city (JP)

(21) Appl. No.: 12/805,395

(22) Filed: Jul. 29, 2010

(30) Foreign Application Priority Data
Sep. 9, 2009 (JP) 2009-208293

(51) Int. Cl. G06F 17/30

(52) U.S. Cl. 707/775; 707/E17.014

(57) ABSTRACT

A search unit searches an address coinciding with a search character string inputted by a user, with reference to stored address data. A district detection unit detects a character string, which coincides with a district of the search character string. A nearby district search unit searches a nearby district in the vicinity of the district specified by a detected character string, based on stored position information on the district. When it is determined that a coinciding address does not exist, a re-search unit replaces the character string of the district of the search character string with the character string of the searched nearby district to generate an after-replacement string. The re-search unit further re-searches an address coinciding with the after-replacement string with reference to stored address data.

### CROSS REFERENCE TO RELATED APPLICATIONS

This application is based on and incorporates herein by reference Japanese Patent Application No. 2009-208293 filed on Sep. 9, 2009.

### FIELD OF THE INVENTION

The present invention relates to an address search device configured to search an address based on a character string inputted by a user. The present invention relates to a method for searching an address based on a character string inputted by a user.

### BACKGROUND OF THE INVENTION

Conventionally, an address search device is known. One address search device searches an address using an inputted search address character string as a search key and retrieves an address coinciding with the inputted search address character string from an address database. In one example, a navigation device functions as an address search device to perform address search for setting a destination. In this case, a user inputs a search address character string of a destination. Further, the navigation device performs a search based on the inputted search address character string and sets a facility or the like, which includes an address coinciding with the inputted search address character string, as a destination. When a user inputs a search address character string and causes such a navigation device to perform search based on the inputted search address character string, and when the user knows the correct address of the destination, there is no problem. Nevertheless, it is noted that a user does not necessarily know the correct, address. When a user inputs a wrong address, the user may be unable to set a desired destination.

In view of such a problem, for example, Publication of Japanese Unexamined Patent Application No. 2001-229182 (JP-A-2001-229182) proposes an electronic map search method. In the electronic map search method, an inputted search address character string is divided into multiple hierarchies, such as a prefecture, a city, an address number, and the like. Further, when the inputted search address character string does not coincide with date registered in each hierarchy, an entire coincidence rate is calculated. Thus, addresses are sequentially listed in descending or ascending order of the coincidence rate, and proposed sites are provided. In this way, even when a user inputs a wrong address, a user may select a target address from the listed sites. Thus, a user can set a desirable destination.

In specific areas such as the United States, an address is specified by an administrative district (district), a street (avenue), and a number. The administrative district includes a state, a county, a city, and the like. In this case, when a street passes through multiple administrative districts, different address in different administrative districts are specified by the same street. For example, Lincoln Street in Westchester County, New York State passes through both New Rochelle City and Pelham Town. Addresses along the Lincoln Street are denoted by, for example, “New Rochelle City, Lincoln Street, 10” and “Pelham Town, Lincoln Street, 30.”

It is in such a condition, for example, when a correct destination of a user is “Pelham Town, Lincoln Street, 30”, the user may misunderstand that the destination is in New Rochelle City adjacent to Pelham Town. In this case, it is supposed that the user wrongly inputs a search address character string of “New Rochelle City, Lincoln Street, 30” to search an address. In this case, according to the electronic map search method of JP-A-2001-229182, although the user only mistook Pelham Town for New Rochelle City, hierarchies other than the wrong character string (New Rochelle City) are modified and searched. Consequently, a large number of proposed destinations are listed and provided to the user. Thus, the user has to find a correct destination from the large-volume list. Specifically, for example, according to the electronic map search method, a hierarchy of an address number is changed and a character string of “New Rochelle City, Lincoln Street, 20” may be generated. Alternatively, a hierarchy of the street is changed and a character string of “New Rochelle City, Lockwood Street, 30” may be generated. Thus, these generated character strings may be given with higher priority and listed upper than the correct destination.

In addition, in a specific area such as the United States, a street is given with a general street name such as “First Street” and “Park Street.” Therefore, in many cases, different administrative districts around completely different streets are denoted by a same street name and an address number. According to the electronic map search method of JP-A-2001-229182, for example, many administrative districts having addresses including “Lincoln Street, 30” may be listed. That is, many administrative districts other than Pelham Town and irrelevant to the destination of the user is listed. Accordingly, a user is annoyed for selecting a correct destination.

### SUMMARY OF THE INVENTION

In view of the foregoing and other problems, it is an object of the present invention to produce an address search device configured to search a target address even when a user inputs a wrong search address character string due to misunderstanding an administrative district of an address of the target address. It is an object of the present invention to produce a method for searching a target address even when a user inputs a wrong search address character string.

According to one aspect of the present invention, an address search device comprises a storage unit configured to store address data and position information on a district of an address. The address search device further comprises a search unit configured to search an address, which coincides with a search character string inputted by a user, with reference to the address data stored in the storage unit. The address search device further comprises a determination unit configured to determine whether a coinciding address exists according to a search result of the search unit. The address search device further comprises an output unit configured to, when the determination unit determines that a coinciding address exists, output the coinciding address. The address search device further comprises a district detection unit configured to detect a character string, which coincides with a district of the search character string. The address search device further comprises a nearby district search unit configured to search a nearby district in the vicinity of the district, which is specified by the character string detected by the district detection unit, based on the position information on the district stored in the storage unit. The address search device further comprises a re-search unit configured to, when the determination unit determines that a coinciding address does not exist: i) replace a character string of the district of the search character string with a character string of the nearby district, which is searched by the nearby district search unit, to generate an after-replacement search character string; and ii) re-search an address coinciding with the after-replacement search character string with reference to the address data stored in the storage unit.

According to another aspect of the present invention, an address search device comprises a storage unit configured to: i) store address data categorized by a category including at least a district and a street; and ii) store a street being distinguishable from another street having the same name. The address search device further comprises a search unit configured to search an address, which coincides with a search character string inputted by a user, with reference to the address data stored in the storage unit. The address search device further comprises a determination unit configured to determine whether a coinciding address exists according to a search result of the search unit. The address search device further comprises an output unit configured to, when the determination unit determines that a coinciding address exists, output the coinciding address. The address search device further comprises a district detection unit configured to detect a character string, which coincides with a category of a district of the search character string. The address search device further comprises a street detection unit configured to detect a character string, which coincides with a category of a street of the search character string. The address search device further comprises a street identification unit configured to specify a street according to both a district specified by the character string detected by the district detection unit and a street specified by the character string detected by the street detection unit, with reference to the storage unit. The address search device further comprises a nearby district detection unit configured to detect a nearby district, which is different from the district of the search character string, from addresses including the street specified by the street identification unit, with reference to the storage unit. The address search device further comprises a re-search unit configured to, when the determination unit determines that a coinciding address does not exist: i) replace the character string of the district of the search character string with the character string of the nearby district searched by the nearby district search unit to generate an after-replacement search character string; and ii) re-search an address coinciding with the after-replacement search character string with reference to the address data stored in the storage unit.

According to another aspect of the present invention, an address search device comprises a storage unit configured to: i) store address data categorized by a category including at least a district; and ii) store position information on each district of an address. The address search device further comprises a search unit configured to search an address, which coincides with a search character string inputted by a user, with reference to the address data stored in the storage unit. The address search device further comprises a determination unit configured to determine whether a coinciding address exists according to a search result of the search unit. The address search device further comprises an output unit configured to, when the determination unit determines that a coinciding address exists, output the coinciding address. The address search device further comprises a district detection unit configured to detect a character string, which coincides with a category of a district of the search character string. The address search device further comprises a re-search unit configured to, when the determination unit determines that a coinciding address does not exist, re-search an address coinciding with a character string portion of the search character string excluding the character string detected by the district detection unit, with reference to address data portion, excluding the category of the district of the address data, stored in the storage unit. The address search device further comprises a list display unit configured to, when the re-search unit finds a plurality of addresses: i) generate a list of the plurality of addresses each including a district, which is near the district specified by the character string detected by the district detection unit, in order of distance according to the position information on the district stored in the storage unit; and ii) indicate the list to a user.

According to another aspect of the present invention, a method for searching an address based on a character string inputted by a user, the method comprises accepting a search character string inputted by a user. The method further comprises searching an address, which coincides with the search character string, with reference to stored address data. The method further comprises determining whether a coinciding address exists according to a result of the searching. The method further comprises, when the determining determines that a coinciding address exists, i) outputting the coinciding address. The method further comprises, when the determining determines that a coinciding address does not exist, i) detecting a character string, which coincides with a district of the search character string; ii) searching a nearby district in the vicinity of the district, which is specified by the detected character string, based on stored position information on the district; iii) replacing a character string of the district of the search character string with a character string of the searched nearby district to generate an after-replacement search character string; and iv) re-searching an address coinciding with the after replacement search character string with reference to the stored address data.

According to another aspect of the present invention, a method for searching an address based on a character string inputted by a user, the method comprises accepting a search character string inputted by a user. The method further comprises searching an address, which coincides with the search character string, with reference to stored address data, which is categorized by a category including at least a district and a street, the street being distinguishable from another street having the same name. The method further comprises determining whether a coinciding address exists according to a result of the searching. The method further comprises, when the determining determines that a coinciding address exists, i) outputting the coinciding address: The method further comprises, when the determining determines that a coinciding address does not exist, i) detecting a character string, which coincides with a category of a district of the search character string; ii) detecting a character string, which coincides with a category of a street of the search character string; iii) specifying a street according to both a district specified by the detected character string and a street specified by the detected character string with reference to the stored address data; iv) detecting a nearby district, which is different from the district of the search character string, from addresses including the specified street, with reference to the storage unit; v) replacing the character string of the district of the search character string with the character string of the searched nearby district to generate an after-replacement search character string; and vi) re-searching an address coinciding with the after-replacement search character string with reference to the stored address data.

According to another aspect of the present invention, a method for searching an address based on a character string inputted by a user, the method comprises accepting a search character string inputted by a user. The method further comprises searching an address, which coincides with the search character string, with reference to stored address data categorized by a category including at least a district. The method further comprises determining whether a coinciding address exists according to a result of the searching. The method further comprises, when the determining determines that a coinciding address exists, i) outputting a coinciding address. The method further comprises, when the determining determines that a coinciding address does not exist, ii) detecting a character string, which coincides with a category of a district of the search character string; iii) re-searching an address coinciding with a character string portion of the search character string excluding the detected character string, with reference to stored address data portion, excluding the category of the district of stored address data. The method further comprises, when the re-searching finds a plurality of addresses: i) generating a list of the plurality of addresses each including a district, which is near the district specified by the detected character string, in order of distance according to stored position information on the district; and ii) indicating the list to a user.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation device;

FIG. 2 is an explanatory view showing a part of address data stored in an information storage unit;

FIG. 3 is an explanatory view showing adjacency information of cities;

FIG. 4A is an explanatory view showing an address input screen of a display device when a user inputs a search address character string; FIG. 4B is an explanatory view showing a street input screen of the display device, and FIG. 4C is an explanatory view showing a city input screen of the display device;

FIG. 5 is a flow chart showing an address search operation according to a first embodiment; and

FIG. 6 is a flow chart showing an address search operation according to a second embodiment.

### DETAILED DESCRIPTION OF PREFERRED EMBODIMENTS

As follows, embodiments will be described with reference to drawings. In the present embodiment, an address retrieval device is applied to a car navigation device mounted in a vehicle. The present invention is not limited to the following embodiment and may encompass various forms as long as such various forms is in a technical scope of the present invention.

### First Embodiment

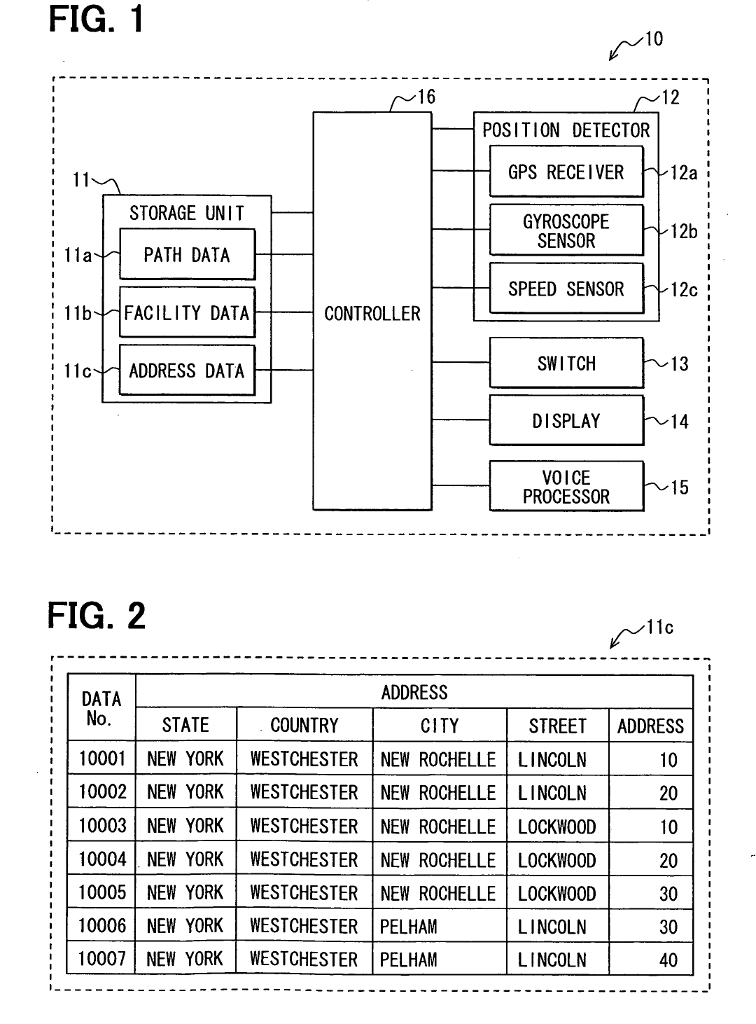

FIG. 1 is a block diagram showing a structure of a car navigation device 10 according to the present embodiment. The car navigation device 10 includes an information storage unit 11, a self-vehicle position detector unit 12, an operation switch device 13, a display device 14, a voice processing device 15, and a control unit 16.

The information storage unit 11 stores path data 11a for searching a path to a destination, facility data 11b including unitized map information for drawing a map on the display device 14, address data 11c including hierarchized addresses of facilities, image and voice data (not shown) for a guidance operation, and the like. The information storage unit 11 may be a storage medium such as a read only storage device, e.g., a read only memory (ROM), a rewritable storage device, e.g., a hard disk drive and a memory device, and/or the like.

The path data 11a includes road map information, which is network information including nodes and links associated with each other. Each node is a point specified by the latitude and the longitude. Each link connects adjacent nodes. Each link corresponding to each road is added with information such as an attribute indicating a highway, a main trunk road, and the like, a road classification such as a thin street, a regulation such as a right and left turn prohibition, a one-way traffic regulation, and other information such as a road shape, a link length, a width, the number of lanes, and a slope. Each link is assigned with a cost according to such information. The control unit 16 performs an optimal path calculation based on the network information and the cost stored in the path data 11a by using a generally-known Dijkstra method or the like such that summation of the values of cost become the minimum.

The facility data 11b includes polygon data of facilities, background data, position information, facility data number, and the like. The polygon data include polygon data of facilities such as a road, a track, a building, and private land. The background data is for drawing a geographical feature of a sea, a river, and the like. The position information and facility data number are associated with the various facilities on a map.

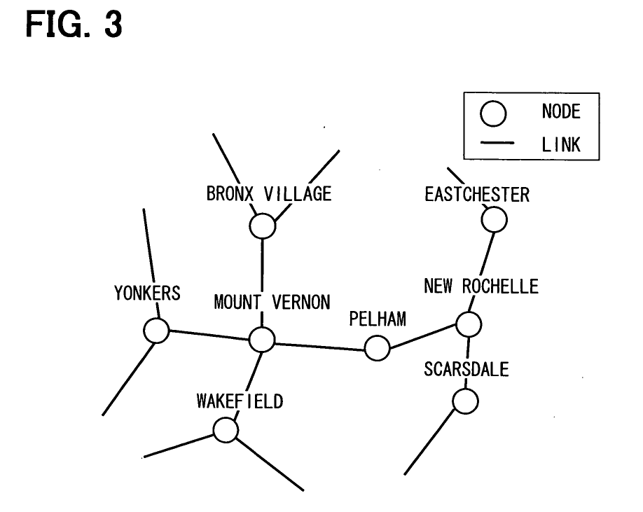

As shown in FIG. 2, the address data 11c includes the facility data number and the hierarchically classified address data, which are associated with each other. The address data 11c includes five categories including a state, a county, a city, a street (avenue), and an address. The category of the city may include a city, a ward, a town, and a village. For example, the facility corresponding to the facility data number “100001” has an address specified by “New York State, Westchester County, New Rochelle City, Lincoln Street, 10.” As shown in FIG. 3, the address data 11c includes adjacency information, which is network information specifying cities each being adjacent to cities. The adjacency information is formed by connecting adjacent cities as nodes via a link. For example, a node specifying New Rochelle is connected with nodes respectively specifying Pelham Town, Scarsdale Town, and Eastchester Town via links. Therefore, it is possible to obtain information specifying that cities adjacent to New Rochelle City are Pelham Town, Scarsdale Town, and Eastchester Town.

The self-vehicle position detector unit 12 includes a GPS receiver 12a, a gyroscope sensor 12b, and a vehicle speed sensor 12c. The GPS receiver 12a receives a radio wave transmitted from a global positioning system (GPS) through a GPS antenna thereby to detect the self-vehicle position and the present time. The gyroscope sensor 12b detects a magnitude of a rotary motion caused in the vehicle. The vehicle speed sensor 12c detects a speed of the vehicle. The self-vehicle position detector unit 12 calculates the present position of the vehicle, as a group of position coordinates and a traveling direction based on these detection signals. Each of the sensors 12a to 12c has an error caused by difference in the detecting method and character. Therefore, the sensors 12a to 12c complement errors to each other so as to detect the self-vehicle position. The self-vehicle position detector unit 12 may include a part of the above-described sensors. The self-vehicle position detector unit 12 may further include a geomagnetism sensor for detecting a traveling direction according to a geomagnetism, a rotation angle sensor of a steering wheel, and the like.

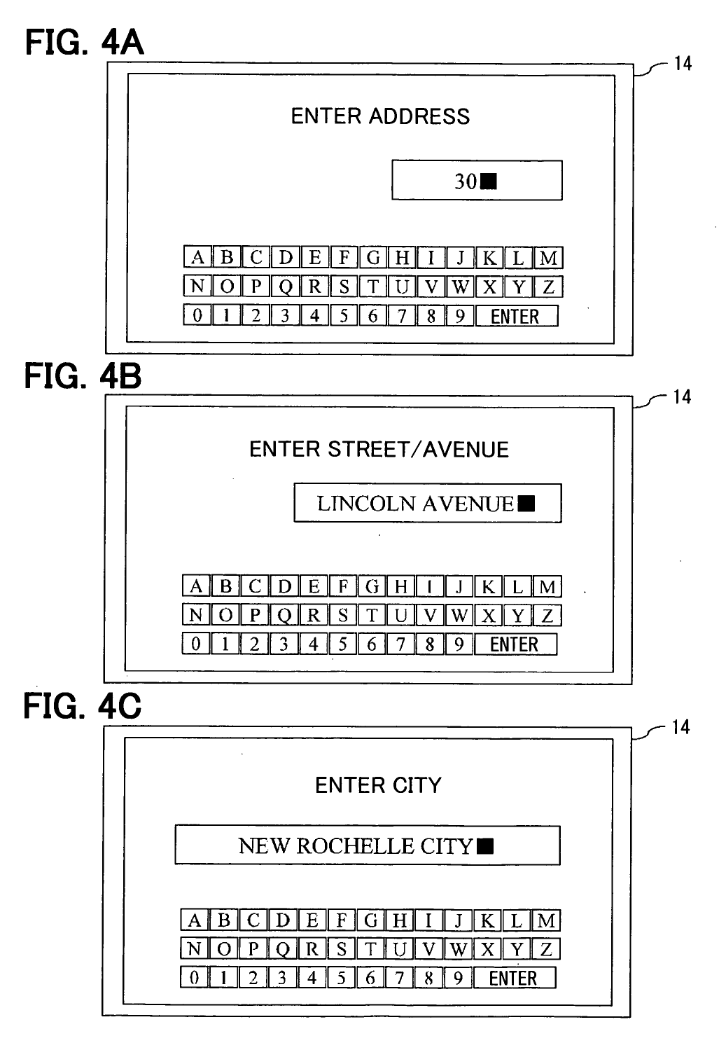

The operation switch group 13 may include a touch panel, which is integrated with the display device 14 and mounted on a display screen, and a button switch provided around the display device 14. The touch panel and the display device 14 are stacked one another and integrated. The touch panel may employ a pressure-sensitive sensor, an electromagnetic induction sensor, an electric capacity sensor, or a sensor including a combination of two or three of these sensors. A user may perform various input operations to the navigation device 10 via the operation switch device 13. FIGS. 4A to 4C show the display device 14 when a user inputs an address of a destination. FIG. 4A shows a screen when a user inputs a number corresponding to an address of a destination. FIG. 4B shows a screen when the user inputs a street (avenue) corresponding to the address of the destination. FIG. 4C shows a screen when the user inputs an administrative district (district) such as a city, a ward, a town, and a village, corresponding to the address of the destination. A user can input a character string to specify an address to be searched by pressing buttons with a finger. Each of the buttons is indicated on the screen to show an alphabet and a number. The screen functions as a touch panel.

The display device 14 includes, for example, a liquid crystal display (LCD) configured to indicate an object in color. The screen of the display device 14 indicates a map including the polygon data and the background data of the facility data 11b. The screen of the display device 14 further indicates a mark specifying the current position of the self-vehicle, a guidance path to the destination, and the like, superimposed on the map. A sign of various facilities, a name, a mark, a traffic congestion information item, and the like may be superimposed on the map and indicated on the screen of the display device 14. The display device 14 may be a liquid crystal display. Alternatively, the display device 14 may be one of a plasma display, an organic EL display, and the like.

The voice processing device 15 includes speakers to output various guidance voice information based on the voice data stored in the information storage unit 11

The control unit 16 mainly includes, for example, a generally-known microcomputer including a CPU, a ROM, a RAM, an I/O device, and a bus line, which connects thereamong. The control unit 16 executes a program stored in the ROM or the like to perform a map indicating operation, an address search operation, and the like. Specifically, in the map indicating operation, the control unit 16 causes the display device 14 to indicate a map in a range instructed by a user through the operation switch device 13. In the address search operation, the control unit 16 searches an address based on the character string of the address, which is inputted by the user, with reference to the address data 11c.

In the present embodiment, the information storage unit 11 may be equivalent to a storage unit. In the present embodiment, the control unit 16 may be equivalent to a search unit, a determination unit, an output unit, a district detection unit, a nearby district search unit, a re-search unit, a street detection unit, and a street identification unit. In the present embodiment, the display device 14 may be equivalent to a re-search result indication unit and a list display unit.

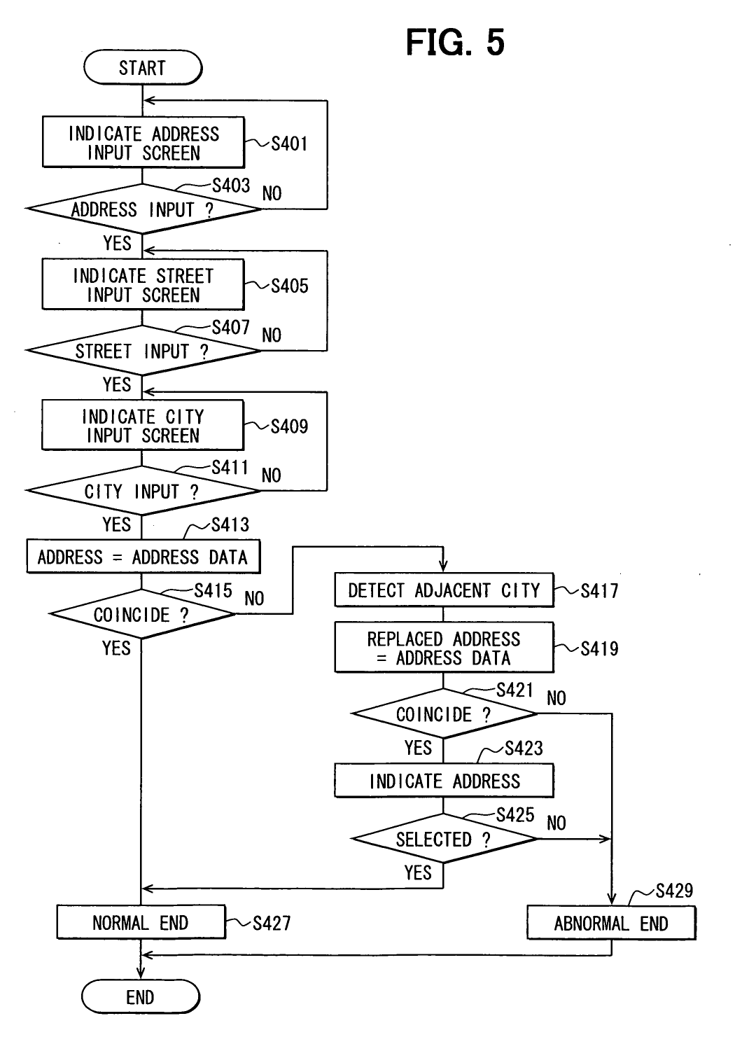

As follows, an address search operation performed by the control unit 16 will be described with reference to the flow chart of FIG. 5. The processings in the flow chart are performed by executing a computer program stored in the control unit 16.

The address search operation is started when a user inputs a search address character string so as to set a desired destination and/or so as to cause indication of a map close to the desired address. First, at step S401 of FIG. 4A, a number input screen is indicated. At step S403, it is determined whether a number is inputted by a user. When a number is inputted, step S403 makes a positive determination. In this case, the processing proceeds to step S405. Alternatively, when a number is not inputted, step S403 makes a negative determination. In this case, the processing returns to step S401 and indication of the number input screen is continued.

At step S405, a street input screen shown in FIG. 4B is indicated. At step S407, it is determined whether a street is inputted by a user. When a street is inputted, step S407 makes a positive determination. In this case, the processing proceeds to step S409. Alternatively, when a street is not inputted, step S407 makes a negative determination. In this case, the processing returns to step S405 and indication of the street input screen is continued.

At step S409, a city input screen shown in FIG. 4C is indicated. At step S411, it is determined whether a city is inputted by a user. When a city is inputted, step S411 makes a positive determination. In this case, the processing proceeds to step S413. Alternatively, when a city is not inputted, step S411 makes a negative determination. In this case, the processing returns to step S409 and indication of the city input screen is continued.

At step S413, the search address character string including the number, the street, the city inputted by a user is compared with addresses stored in the address data 11c. At step S415, it is determined whether an address, which coincides with the search address character string, exists according to the comparison result at step S413. When an address, which coincides with the search address character string, exists, step S413 makes a positive determination. In this case, the processing proceeds to step S427, at which the address search operation is normally terminated. When the address search operation is normally terminated, a destination may be set to a facility of the searched address. Alternatively, a map close to the searched address may be indicated. When an address, which coincides with the search address character string, does not exist, step S415 makes a negative determination. In this case, the processing proceeds to step S417.

At step S417, a city adjacent to the city inputted at step S411 is detected. The adjacent city can be detected from the network information of the address data 11c. At step S419, an after-replacement search address character string is generated by replacing the city inputted at step S411 with the adjacent city detected at step S417. Further, the after-replacement search address character string is compared with addresses of the address data 11c. When multiple adjacent cities are detected at step S417, the after-replacement search address character string is generated for each of the detected adjacent cities, and each generated after-replacement search address character string is compared with the addresses of the address data 11c.

At step S421, it is determined whether an address, which coincides with the after-replacement search address character string, exists in the address data 11c according to the comparison result at step S419. When an address, which coincides with the after-replacement search address character string, exists, step S421 makes a positive determination. In this case, the processing proceeds to step S423. Alternatively, when an address, which coincides with the after-replacement search address character string, does not exist, step S421 makes a negative determination. In this case, the processing proceeds to step S429, at which the address search operation is abnormally terminated. When the address search operation is abnormally terminated, the display device 14 and the voice processing device 15 are caused to notify a user that an address coinciding with the search address character string was not searched. Thus, the present address search operation is terminated.

When the step S421 makes a positive determination, at step S423, the display device 14 is caused to indicate the address, which coincides with the after-replacement search address character string. At step S425, it is determined whether the address indicated at step S423 is selected by a user. When the address is selected by a user, step S425 makes a positive determination. In this case, the processing proceeds to step S427, at which the address search operation is normally terminated. Alternatively, when the address is not selected by a user, step S425 makes a negative determination. In this case, it is determined that the address requested by a user cannot be searched. Thus, the processing proceeds to step S429, at which the address search operation is abnormally terminated.

As described above, according to the present embodiment, it is determined whether an address, which coincides with the search address character string inputted by a user, exists in the address data 11c. When it is determined that the address, which coincides with the inputted search address character string, does not exist in the address data 11c, the city of the search address character string is replaced with a city adjacent to the city included in the inputted search address character string, and re-searched. Thus, the re-search result is indicated to a user. The user can select the searched address when determining that the searched address is a target address according to the indicated result. In this way, an address with a high possibility to be a target can be selectively proposed to a user. Therefore, even in a case where a user misunderstands a city and wrongly inputs an address with such a misunderstanding, an address desired by a user can be searched.

It is noted that a user is apt to confuse a target city of a target address and a city near the target city. Therefore, an address different in the number and/or the street may be less possible to be the target city supposed by a user. In addition, an address far from the inputted target city may be also less possible to be the target city supposed by a user. According to the present embodiment, such an address being less possible to be the target city supposed by a user is restricted from being outputted as a search result. Therefore, an address search convenient for a user can be performed.

Further, according to the present embodiment, re-searching is performed only by a number of cities adjacent to the inputted city. Therefore, it is not necessary to assign of a weigh to each of hierarchies. Thus, a target address supposed by a user can be searched without increase in a load for the searching operation.

(First Modification)

Subsequently, a first modification of the first embodiment will be described. In the present modification, when it is determined that multiple addresses, which coincide with the after-replacement search address character string, exists in the address data 11c, a list of the multiple addresses, which are determined to be coincide, is generated, and the display device 14 is caused to indicate the generated list. For example, it is supposed that a user sets “Hoboken City, Park Street, 100” to the search address character string. When an address, which coincides with the presently set search address character string of “Hoboken City, Park Street, 100” does not exist in the address data 11c, step S415 makes a negative determination in the present embodiment. In this case, cities adjacent to Hoboken City are searched from the address data 11c, and the name string of the city of “Hoboken City, Park Street, 100” is replaced to each of the searched cities adjacent to Hoboken City. Specifically, the cities adjacent to Hoboken City are, for example, Union City and Jersey City, the Manhattan Ward and Bronx Ward of New York City, and the like. Thus, re-search is performed. As a result of the re-search, when both two addresses of “Union City, Park Street, 100” and “the Manhattan City, Park Street, 100” exist in the address date 11c, a list of both the two addresses is generated, and the display device 14 is caused to indicate the generated list. A user can select one of the two addresses included in the generated list. In this way, only addresses with a high possibility to be a target address are indicated as a search result to a user. Therefore, a user can select a target address with convenience.

(Second Modification)

Subsequently, a second modification of the first embodiment will be described. In the present modification, replacement is performed with not the city, which is adjacent to the inputted city, but another city, through which an inputted street passes, when performing the re-search. The address data 11c includes an inputted street, which passes through multiple cities, and the multiple cities, through which the inputted street passes, in order to detect other city, through which the inputted street passes. Specifically, a list is generated for each street associated with cities, through which the street passes. It is noted that each street is associated with an ID number, for example. Therefore, even when the name of two different streets is the same, the different streets can be identified from each other. Specifically, for example, it is possible to obtain information specifying that Lincoln Street, which exists in New York State, Westchester County, passes through three different administrative districts including New Rochelle City, Mount Vernon City, and Pelham Town. It is supposed that a street, which is inputted by a user, passes through a city, which is inputted, by the user. In this case, the street can be specified according to the name of the city and the name of the street. Subsequently, other cities, through which the street passes, are detected with reference to the address data 11c. When re-search is performed, the detected cities are replaced.

Specifically, for example, it is supposed that a user inputs “New Rochelle City, Lincoln Street, 30” into the search address character string. When an address, which coincides with the inputted search address character string, does not exist in the address data 11c, step S415 makes a negative determination in the present embodiment: In this case, it is first determined whether Lincoln Street passes New Rochelle City with reference to the address data 11c. When Lincoln Street does not pass through New Rochelle City, the operation same as step S417 and the subsequent processings is performed in the present embodiment. Alternatively, when Lincoln Street passes through New Rochelle City, New Rochelle City is replaced with Mount Vernon City and Pelham Town City, which are the other cities through which Lincoln Street passes. Thus, the re-search is performed. When “Mount Vernon City, Lincoln Street, 30” and “Pelham Town, Lincoln Street, 30” coincide with data in the address data 11c, the coincide addresses is indicated as a search result to a user.

According to the present modification, a city name of the inputted search address character string is replaced with a city name, which is highly possible to be misunderstood by a user. Therefore, an address search with further convenience can be proposed to a user.

### Second Embodiment

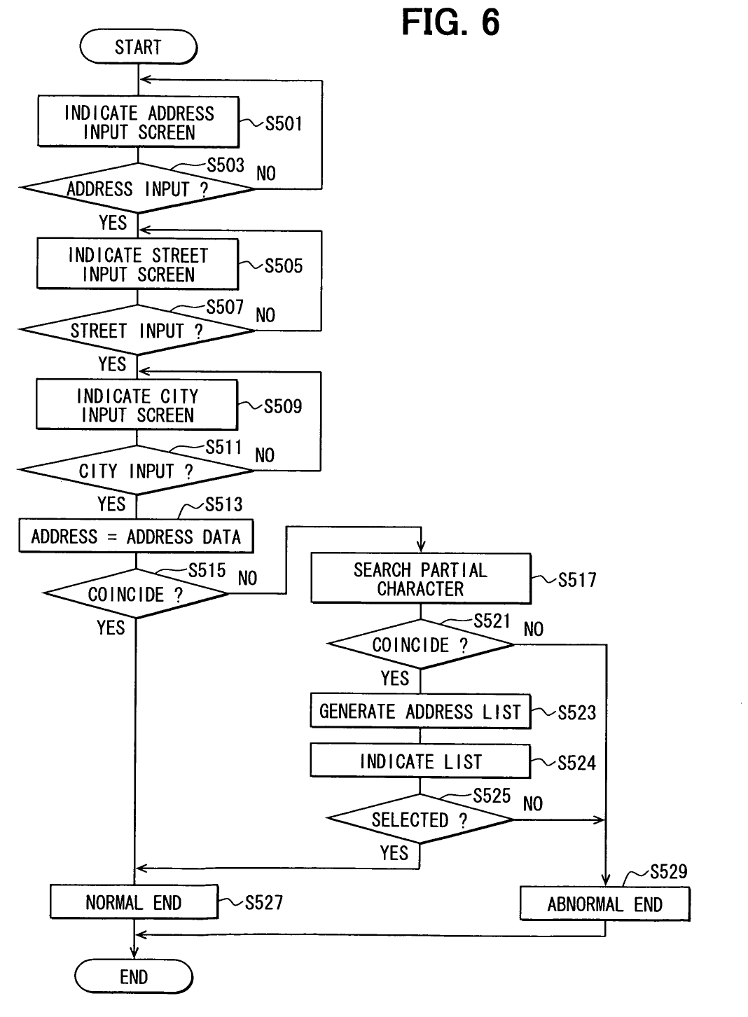

The configuration of the navigation device 10 in the present embodiment is substantially the same as that of the first embodiment, and therefore detailed description of the configuration is omitted. As follows, an address search operation performed by the control unit 16 will be described with reference to the flow chart of FIG. 6. The processings in the flow chart are performed by executing a computer program stored in the control unit 16. the processings from step S501 to step S515 are substantially equivalent to step S401 to step S415 in the first embodiment. Therefore, descriptions for step S501 to step S515 are omitted.

At step S517 in FIG. 6, a portion of a search address character string excluding a city inputted at step S511 is compared with addressed included in the address data 11c, and search is performed. Specifically, for example, when a search address character string of “New Rochelle City, Lincoln Street, 30” is inputted, “New Rochelle City”, which corresponds to the city name, is excluded from the search address character string. Thus, search is performed by using the character string of “Lincoln Street, 30.” In this case, search is performed while a hierarchy of the city is ignored.

When an address, which coincides with the character string of “Lincoln Street, 30” exists as a result of the search at step 517, step S521 makes a positive determination. In this case, the processing proceeds to step S523. Alternatively, when an address, which coincides with the character string of “Lincoln Street, 30” does not exist, step S521 makes a negative determination. In this case, the processing proceeds to step S529, at which the address search operation is abnormally terminated. When the address search operation is abnormally terminated, the display device 14 and the voice processing device 15 are caused to notify a user that an address corresponding to the search address character string was not searched. Thus, the present address search operation is terminated.

When the step S521 makes a positive determination, at step S523, a list of addresses, which coincide with the character string, is generated. When multiple addresses coincide with the character string, the search result including the multiple addresses is sorted in the ascending order from a city in the vicinity of the city inputted at step S511, and a list including the sorted search result is generated. A degree of the vicinity is calculated based on the network information including in the address data 11c. The minimum number of links from the node specifying the city inputted at step S511 to the node specifying the city of one of the searched addresses may be used as the degree of the vicinity. For example, it is supposed that the minimum number of links is one between one city inputted at step S511 and a city adjacent to the inputted one city. In addition, it is supposed that the one city and the adjacent city interpose another one city therebetween. In this case, the minimum number of links is two.

At step S524, the display device 14 is caused to indicate the list of addresses generated at step S523. At step S525, it is determined whether one of the addresses in the list indicated at step S423 is selected by a user. When the address is selected by a user, step S525 makes a positive determination. In this case, the processing proceeds to step S527, at which the address search operation is normally terminated. When the address search operation is normally terminated; a destination may be set to a facility of the searched address. Alternatively, a map close to the searched address may be indicated. Alternatively, when the address is not selected by a user, step S525 makes a negative determination. In this case, it is determined that the address requested by a user cannot be searched. Thus, the processing proceeds to step S529, at which the address search operation is abnormally terminated.

As described above, according to the present embodiment, the re-search result is sorted in order to prioritize an address of a city, which is in the vicinity of a city corresponding to a search address character string inputted by a user. Further, a list including the sorted re-search result is generated and indicated. In this way, a user can select a target address from the list in view of the search result. Thus, an address with a high possibility to be a target address for a user can be prioritized and proposed to a user. Therefore, even in a case where a user misunderstands a city and wrongly inputs an address with such a misunderstanding, an address desired by a user can be searched with convenience.

In the above embodiments, the term of “city” may include a city, a ward, a town, and a village. That is, in the above embodiments, the description of a city, a ward, a town, and a village may have been represented by the term of “city” for simplifying the explanation.

Summarizing the above embodiments, an address search device comprising:

a storage unit configured to store address data and position information on each administrative district of an address;

a search unit configured to search an address, which coincides with a search address character string inputted by a user, with reference to address data stored in the storage unit;

a determination unit configured to determine whether a coinciding address exists according to a result of search performed by the search unit;

an output unit configured to, when the determination unit determines that a coinciding address exists, output the coinciding address;

an administrative district detection unit configured to detect a character string corresponding to an administrative district of the search address character string inputted by a user;

a nearby administrative district search unit configured to search a nearby administrative district in the vicinity of the administrative district, which is specified by the character string detected by the administrative district detection unit, based on the position information on the administrative district stored in the storage unit; and

a re-search unit configured to, when the determination unit determines that a coinciding address does not exist: i) replace the character string of the administrative district of the search address character string with the character string of the nearby administrative district searched by the nearby administrative district search unit to generate an after-replacement search address character string; and ii) re-search an address coinciding with the after-replacement search address character string with reference to the address data stored in the storage unit.

In this way, even when a user misunderstands an administrative district of an address to be searched, and consequently when the user inputs a search address character string of an address including a wrong administrative district, the administrative district of the search address character string is replaced to a nearby administrative district. In addition, an address including the replaced nearby administrative district is re-searched. Therefore, a user can search a target address.

The nearby administrative district search unit is further configured to search an administrative district, which is adjacent to the administrative district specified by the character string detected by the administrative district detection unit, as a nearby administrative district. When a user misunderstands a target administrative district of the address, the user may possibly misunderstand an administrative district, which is adjacent to a correct administrative district, as the target administrative district. Therefore, an administrative district such as a city, a ward, a town, and a village adjacent to the administrative district specified by the search address character string is replaced to an adjacent administrative district; and re-search is performed. Thus, an operation load of the re-search can be reduced.

The address search device further comprising:

a re-search result indication unit configured to, when the determination unit determines that an address coinciding with the after-replacement search address character string exists according to a re-search result, indicate the address coinciding with the after-replacement search address character string to a user.

The output unit is further configured to, when the address indicated by the re-search result indication unit is selected by a user, output the address coinciding with the after-replacement search address character string. In this manner, a user can confirm whether the indicated address is a target address, and the user can select the indicated address after the confirmation. Thus, an accuracy of address search can be enhanced.

An address search device comprising:

a storage unit configured to: store address data categorized by a category including at least an administrative district and a street; and store streets, which can be distinguishable even when the streets have the same name;

a search unit configured to, search an address, which coincides with a search address character string inputted by a user, with reference to address data stored in the storage unit;

a determination unit configured to determine whether a coinciding address exists according to a result of search performed by the search unit;

an output unit configured to, when the determination unit determines that a coinciding address exists, output the coinciding address;

an administrative district detection unit configured to detect a character string, which coincides with a category of an administrative district of a search address character string;

a street detection unit configured to detect a character string, which coincides with a category of a street of a search address character string;

a street identification unit configured to specify a street according to an administrative district specified by a character string detected by the administrative district detection unit and a street specified by a character string detected by the street detection unit with reference to the storage unit;

a nearby administrative district detection unit configured to detect a nearby administrative district, which is different from an administrative district of a search address character string, from an address including the street specified by the street identification unit with reference to the storage unit; and

a re-search unit configured to, when the determination unit determines that a coinciding address does not exist: i) replace the character string of the administrative district of the search address character string with the character string of the nearby administrative district searched by the nearby administrative district search unit to generate an after-replacement search address character string; and ii) re-search an address coinciding with the after-replacement search address character string with reference to the address data stored in the storage unit.

When a user misunderstands a target administrative district of a target position, the user may possibly misunderstand another administrative district, through which a common street passes, as the target administrative district. Therefore, when performing re-search, another administrative district, through which a street specified by an inputted search address character string passes, may be detected. In addition, the inputted search address character string may be replaced by the detected administrative district. In this way, even when a user misunderstands an administrative district of an address to be searched, and consequently when the user inputs a search address character string of an address including a wrong administrative district, the administrative district of the search address character string is replaced to another administrative district, through which the street specified by the search address character string passes. In addition, an address including the replaced another administrative district is re-searched. Therefore, a user can search a target address.

An address search device further comprising:

a re-search result indication unit configured to, when the determination unit determines that an address coinciding with the after-replacement search address character string exists according to a re-search result of the re-search unit, indicate the address coinciding with the after-replacement search address character string to a user.

The output unit is further configured to, when the address indicated by the re-search result indication unit is selected by a user, output the address coinciding with the after-replacement search address character string.

In this manner, a user can confirm whether the indicated address is a target address, and the user can select the indicated address after the confirmation. Thus, an accuracy of address search can be enhanced.

An address search device comprising:

a storage unit configured to: store address data categorized by a category including at least an administrative district; and store position information on each administrative district of an address;

a search unit configured to search an address, which coincides with a search address character string inputted by a user, with reference to address data stored in the storage unit;

a determination unit configured to determine whether a coinciding address exists according to a result of search performed by the search unit;

an output unit configured to, when the determination unit determines that a coinciding address exists, output the coinciding address;

an administrative district detection unit configured to detect a character string, which coincides with a category of an administrative district of a search address character string;

a re-search unit configured to, when the determination unit determines that a coinciding address does not exist, re-search an address coinciding with a character string of the search address character string other than the character string detected by the administrative district detection unit with reference to address data other than the category of the administrative district of the address data stored in the storage unit; and

a list display unit configured to, when the re-search unit re-searches multiple addresses: i) generate a list of the multiple addresses each including an administrative district, which is near the administrative district specified by the character string detected by the administrative district detection unit, in order of distance according to the position information on the administrative district stored in the storage unit; and ii) indicate the list to a user.

When a user misunderstands an administrative district of a target address, and when the user inputs a wrong address different from a correct search address character string, the correct address is possibly another administrative district near the wrong administrative district. In view of such a condition, a priority is given to the addresses in order of distance, i.e., in order of possibility to be the target address. In addition, the addresses given with a priority is listed. Further, the user can select an address with reference to the list. Thus, the user can search the address with convenience.

The above structures of the embodiments can be combined as appropriate.

The above processings such as calculations and determinations are not limited being executed by the control unit 16. The control unit may have various structures including the control unit 16 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An address search device comprising:
a storage unit configured to store address data and position information on a district of an address;
a search unit configured to search an address, which coincides with a search character string inputted by a user, with reference to the address data stored in the storage unit;
a determination unit configured to determine whether a coinciding address exists according to a search result of the search unit;
an output unit configured to, when the determination unit determines that a coinciding address exists, output the coinciding address;
a district detection unit configured to detect a character string, which coincides with a district of the search character string;
a nearby district search unit configured to search a nearby district in the vicinity of the district, which is specified by the character string detected by the district detection unit, based on the position information on the district stored in the storage unit; and
a re-search unit configured to, when the determination unit determines that a coinciding address does not exist:
i) replace a character string of the district of the search character string with a character string of the nearby district, which is searched by the nearby district search unit, to generate an after-replacement search character string; and
ii) re-search an address coinciding with the after-replacement search character string with reference to the address data stored in the storage unit.

2. The address search device according to claim 1, wherein
the nearby district search unit is further configured to search a district, which is adjacent to the district specified by the character string detected by the district detection unit, as a nearby district.

3. The address search device according to claim 1, further comprising:
a re-search result indication unit configured to, when the determination unit determines that an address coinciding with the after-replacement search character string exists according to a re-search result, indicate the address coinciding with the after-replacement search character string to a user, wherein,
the output unit is further configured to, when the address indicated by the re-search result indication unit is selected by a user, output the address coinciding with the after-replacement search character string.

4. An address search device comprising:
a storage unit configured to:
i) store address data categorized by a category including at least a district and a street; and
ii) store a street being distinguishable from another street having the same name;
a search unit configured to search an address, which coincides with a search character string inputted by a user, with reference to the address data stored in the storage unit;
a determination unit configured to determine whether a coinciding address exists according to a search result of the search unit;
an output unit configured to, when the determination unit determines that a coinciding address exists, output the coinciding address;
a district detection unit configured to detect a character string, which coincides with a category of a district of the search character string;
a street detection unit configured to detect a character string, which coincides with a category of a street of the search character string;
a street identification unit configured to specify a street according to both a district specified by the character string detected by the district detection unit and a street specified by the character string detected by the street detection unit, with reference to the storage unit;
a nearby district detection unit configured to detect a nearby district, which is different from the district of the search, character string, from addresses including the street specified by the street identification unit, with reference to the storage unit; and
a re-search unit configured to, when the determination unit determines that a coinciding address does not exist:
i) replace the character string of the district of the search character string with the character string of the nearby district searched by the nearby district search unit to generate an after-replacement search character string; and
ii) re-search an address coinciding with the after-replacement search character string with reference to the address data stored in the storage unit.

5. The address search device according to claim 4, further comprising:
a re-search result indication unit configured to, when the determination unit determines that an address coinciding with the after-replacement search character string exists according to a re-search result of the re-search unit, indicate the address coinciding with the after-replacement search character string to a user, wherein
the output unit is further configured to, when the address indicated by the re-search result indication unit is selected by a user, output the address coinciding with the after-replacement search character string.

6. An address search device comprising:
a storage unit configured to:
i) store address data categorized by a category including at least a district; and
ii) store position information on each district of an address;
a search unit configured to search an address, which coincides with a search character string inputted by a user, with reference to the address data stored in the storage unit;
a determination unit configured to determine whether a coinciding address exists according to a search result of the search unit;
an output unit configured to, when the determination unit determines that a coinciding address exists, output the coinciding address;
a district detection unit configured to detect a character string, which coincides with a category of a district of the search character string;
a re-search unit configured to, when the determination unit determines that a coinciding address does not exist, re-search an address coinciding with a character string portion of the search character string excluding the character string detected by the district detection unit, with reference to address data portion, excluding the category of the district of the address data, stored in the storage unit; and
a list display unit configured to, when the re-search unit finds a plurality of addresses:
i) generate a list of the plurality of addresses each including a district, which is near the district specified by the character string detected by the district detection unit, in order of distance according to the position information on the district stored in the storage unit; and
ii) indicate the list to a user.

7. A method for searching an address based on a character string inputted by a user, the method comprising:
accepting a search character string inputted by a user;
searching an address, which coincides with the search character string, with reference to stored address data;
determining whether a coinciding address exists according to a result of the searching;
when the determining determines that a coinciding address exists,
i) outputting the coinciding address; and
when the determining determines that a coinciding address does not exist:
ii) detecting a character string, which coincides with a district of the search character string;
iii) searching a nearby district in the vicinity of the district, which is specified by the detected character string, based on stored position information on the district;
iv) replacing a character string of the district of the search character string with a character string of the searched nearby district to generate an after-replacement search character string; and
v) re-searching an address coinciding with the after-replacement search character string with reference to the stored address data.

8. A method for searching an address based on a character string inputted by a user, the method comprising:
accepting a search character string inputted by a user;
searching an address, which coincides with the search character string, with reference to stored address data, which is categorized by a category including at least a district and a street, the street being distinguishable from another street having the same name;
determining whether a coinciding address exists according to a result of the searching;
when the determining determines that a coinciding address exists,
i) outputting the coinciding address; and
when the determining determines that a coinciding address does not exist:
ii) detecting a character string, which coincides with a category of a district of the search character string;
iii) detecting a character string, which coincides with a category of a street of the search character string;
iv) specifying a street according to both a district specified by the detected character string and a street specified by the detected character string with reference to the stored address data;
v) detecting a nearby district, which is different from the district of the search character string, from addresses including the specified street, with reference to the storage unit;
vi) replacing the character string of the district of the search character string with the character string of the searched nearby district to generate an after-replacement search character string; and
vii) re-searching an address coinciding with the after-replacement search character string with reference to the stored address data.

9. A method for searching an address based on a character string inputted by a user, the method comprising:
accepting a search character string inputted by a user;
searching an address, which coincides with the search character string, with reference to stored address data categorized by a category including at least a district;
determining whether a coinciding address exists according to a result of the searching;
when the determining determines that a coinciding address exists;
i) outputting a coinciding address; and
when the determining determines that a coinciding address does not exist;
ii) detecting a character string, which coincides with a category of a district of the search character string;
iii) re-searching an address coinciding with a character string portion of the search character string excluding the detected character string, with reference to stored address data portion, excluding the category of the district of stored address data; and
when the re-searching finds a plurality of addresses:
i) generating a list of the plurality of addresses each including a district, which is near the district specified by the detected character string, in order of distance according to stored position information on the district; and
ii) indicating the list to a user.

10. A computer readable medium comprising instructions executed by a computer, the instructions including the method according to claim 7.

11. A computer readable medium comprising instructions executed by a computer, the instructions including the method according to claim 8.

12. A computer readable medium comprising instructions executed by a computer, the instructions including the method according to claim 9.
